(19) United States
(12) Patent Application Publication
(10) Pub. No.: US 2020/0384689 A1
(43) Pub. Date: Dec. 10, 2020

(54) CONTROLLING POWER LEVELS OF HEATING ELEMENTS

(71) Applicant: HEWLETT-PACKARD DEVELOPMENT COMPANY, L.P., Spring, TX (US)

(72) Inventors: Jordi Bautista Ballester, Sant Cugat del Valles (ES); Luis Garcia Garcia, Sant Cugat del Valles (ES); Emili Sapena Masip, Sant Cugat del Valles (ES)

(21) Appl. No.: 16/608,380

(22) PCT Filed: Jan. 19, 2018
(86) PCT No.: PCT/US2018/014402

§ 371 Date: Oct. 25, 2019

(51) Int. Cl. B29C 64/295; B33Y 10/00; B29C 64/393; B29C 64/165; B33Y 30/00; B33Y 50/02; B28B 1/00; B22F 3/105

(52) U.S. Cl. CPC B29C 64/295; B33Y 10/00; B29C 64/393; B29C 64/165; B22F 2003/1057; B33Y 50/02; B28B 1/001; B22F 3/1055; B33Y 30/00

(57) ABSTRACT

In an example, a method includes monitoring a temperature of a layer of build material within an additive manufacturing apparatus. A power level of a first heating element heating the layer of build material may be controlled based on the monitored temperature and a power level of a second heating element heating the layer of build material may be controlled according to a predetermined power level scheme.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used.

### BRIEF DESCRIPTION OF DRAWINGS

Non-limiting examples will now be described with reference to the accompanying drawings, in which:

FIG. 1 is an example method of additive manufacturing;

FIG. 2 is another example method of additive manufacturing;

FIG. 3 is an example additive manufacturing apparatus;

FIG. 4 is an example of an arrangement of heating elements and heating zones;

FIG. 5 is an example of a heat map; and

FIG. 6 is an example machine readable medium associated with a processor.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a print bed and processed layer by layer, for example within a fabrication chamber.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material heats up/melts, coalesces and solidifies to form a slice of the three-dimensional object in accordance with the pattern. In other examples, coalescence may be achieved in some other manner.

In addition to a fusing agent, in some examples, a print agent may comprise a detailing agent, or coalescence modifier agent, which acts to modify the effects of a fusing agent for example by reducing (e.g. by cooling) or increasing coalescence or to assist in producing a particular finish or appearance to an object. Detailing agent may also be used to control thermal aspects of a layer of build material—e.g. to provide cooling. A coloring agent, for example comprising a dye or colorant, may in some examples be used as a fusing agent or a coalescence modifier agent, and/or as a print agent to provide a particular color for the object. Print agents may control or influence other physical or appearance properties, such as strength, resilience, conductivity, transparency, surface texture or the like.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices defined between parallel planes of the model. Each slice may define a portion of a respective layer of build material that is to be solidified or caused to coalesce by the additive manufacturing system.

In some examples, prior to generating objects, apparatus may undergo calibration and/or checking of the apparatus (where calibration in the context may comprise finding the measured temperature which corresponds to the melting temperature of the build material, given any or any combination of variability in temperature sensors, build material types and batches, apparatus condition, environmental conditions and the like).

In examples of such calibration/checking exercises, a small portion of a few successive layers of build material towards the bottom of a fabrication chamber are caused to fuse by the addition of fusing agent. A ‘blank’ layer (i.e. without fusing agent) of build material is formed on top of this fused patch and heat is applied until the blank layer melts above the fused patch. By leaving a layer of the build material blank, melting occurs relatively slowly, allowing a change in gradient of temperature associated with melting to be readily identified. The exercise may serve to calibrate the heat control set points and as a warning of a fault in the apparatus (for example, if temperature does not increase as anticipated, a heat lamp may not be operating correctly), and the rest of a build operation may be abandoned if a fault is detected.

Such calibration/checking exercises may fail to complete, for example, in the event of a time out, and/or if the build material which does not overlie the fused patch, and which is not intended to fuse, becomes too hot. Inadvertently fusing such surrounding material means that material cannot be recycled in a subsequent build operation, adding cost to the process.

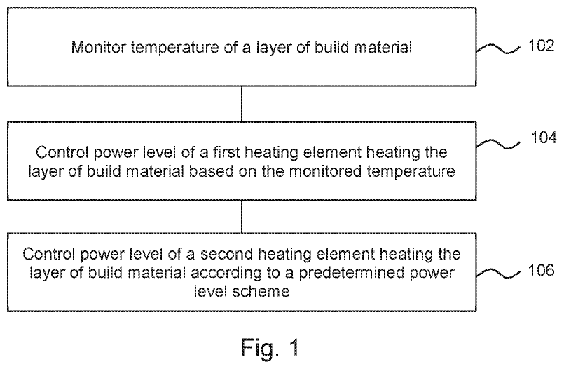

FIG. 1 is an example of a method of additive manufacturing, which may be a layer by layer object generation process, otherwise known as 3D printing. In block 102, a temperature of a layer of build material within an additive manufacturing apparatus is monitored. In some examples, the method may comprise monitoring a plurality of temperatures over the layer. In some examples, a ‘heat map’ of the layer of build material may be acquired, for example using one or more thermal cameras. The heat map may be made up of a plurality of pixels, each corresponding to a region of the layer of build material, and the temperature of each of such pixels/regions may be monitored.

In some examples, as set out in greater detail below, the temperature which is monitored in block 102 comprises or is a temperature of the region of the layer of build material which is not intended to fuse during the object generation process. In some examples, the temperature is a temperature of a region of the layer of build material which does not have fusing agent applied thereto.

Block 104 comprises controlling a power level of a first heating element heating the layer of build material based on the monitored temperature and block 106 comprises controlling a power level of a second heating element heating the layer of build material according to a predetermined power level scheme. Controlling the power level may comprise controlling the average power level over time, for example using pulse width modulation control, which sets the percentage of time for which a heating element is emitting light. In some examples, a steady power output may be provided in block 106. The predetermined power level scheme may be applied independently of any monitored temperature of the print bed.

In some examples, the heating elements may be, for example heat lamps such as infrared heat lamps. However, the heating elements may comprise any thermal energy source. In some examples, the heating elements may be part of an array of heating elements overlying a print bed in an additive manufacturing apparatus.

In some examples, the first heating element is arranged above, or substantially contributes to heating, a region of the layer of build material which is not intended to fuse during the object generation process, whereas the second heating element is positioned above, or substantially contributes to heating, a region of the layer of build material which is intended to fuse. In some examples, object generation apparatus may comprise a plurality of heating elements, for example in the order of 10, 20, 50, or the like, heating elements. In some examples, there may be more than one heating element which heats a particular zone or region of a layer of build material. For example, one heating element may provide a general heating of a region of the layer whereas a second heating element may provide additional heating to a portion of that region of the layer.

The method of FIG. 1 may be carried out during calibration, apparatus checks and/or object generation.

Controlling the power level of the first heating element in block 104 may be thought of as applying ongoing closed-loop control of the first heating element. Controlling a power level of the second heating element in block 106 may comprise applying a fixed or otherwise a predetermined power level or scheme. However, both the first and second heating elements may operate with some level of feedback control, for example being subject to a safety cut-off in the event of significant overheating.

In some examples, heating elements which contribute to heating the build material which is intended to fuse (for example, the build material arranged above a test patch, or the build material to be solidified in generating an object) may be controlled as described for the second heating elements, for example according to a fixed power output regime. However, other heating elements (which may be peripheral heating elements, in particular in the case of a test patch which may be formed in the centre of a print bed) are controlled according to a closed-loop control algorithm based on the temperature of the underlying build material layer.

When compared to a method in which all the heating elements are controlled using fixed temperatures, in the case of a central test patch, the peripheral heating elements may be set to output heat at a lower level than the central heating elements. The central heating element(s) may be controlled to emit heat at a relatively high level, for example around 90-100% of their maximum power output, which may be compared to around 40-50% for the peripheral heating elements. However, using such a predetermined power scheme for all heating elements can result in unnecessary consumption of energy and/or overheating or under heating of the portions of the layer of build material which are not intended to fuse. Over or under heating of the portions of the layer of build material which are not intended to fuse can result in failures of calibration/checking tests for example due to time out or overheating of the build material. Thus by adaptively controlling the heating elements which are not intended to contribute directly to fusing build material, it is more likely that, absent an equipment fault, a test/calibration exercise will complete successfully. Since the melting temperature depends on the heating rate, it is useful to maintain a constant temperature when heating build material to the melting temperature for accurate calibration. However, this need not be applied in regions in which the build material is not intended to melt, and a closed loop control, or feedback mechanism may be employed in heating such regions.

In another example, the method of FIG. 1 may be carried out during generation of an object. The object may be generated based on object model data representing at least a portion of an object to be generated by an additive manufacturing apparatus by fusing build material. The object model data may for example comprise a Computer Aided Design (CAD) model, and/or may for example be a STereoLithographic (STL) data file. In some examples, the first object may be one of a plurality of objects being generated in a single object generation process, i.e. within a single fabrication chamber.

Heating elements which directly contribute to causing a portion of the layer of build material to fuse to form the object may be controlled using a fixed or otherwise predetermined control scheme whereas heating elements which overlie portions of the layer of build material which it is not intended to fuse in that layer may be controlled according to an adaptive (e.g. a feedback, or closed-loop) control algorithm.

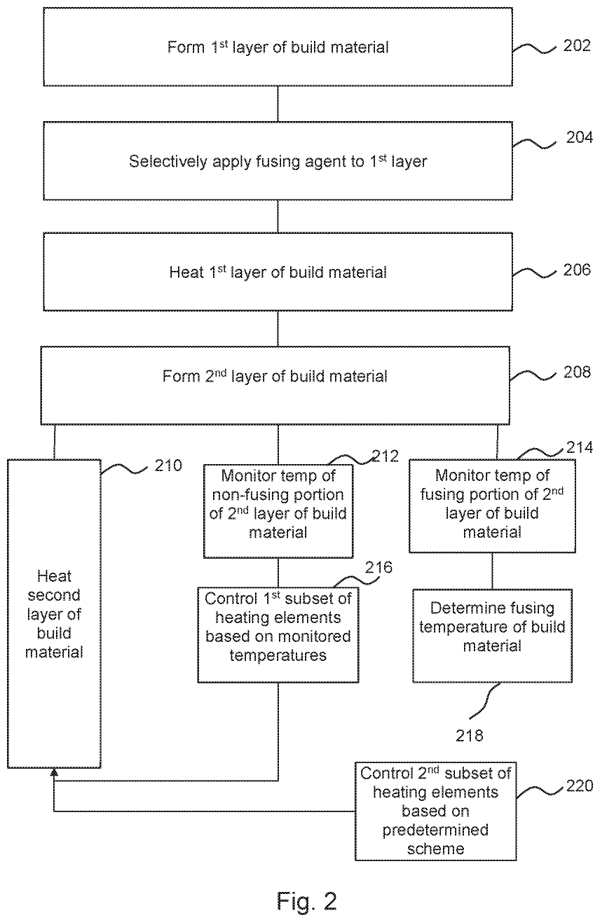

FIG. 2 shows another example of a method for object generation, in this particular example for use in a calibration/checking process of a print apparatus.

Block 202 comprises forming a first layer of build material on a print bed of the additive manufacturing apparatus.

Block 204 comprises selectively applying fusing agent to the first layer of build material. In this example, the fusing agent is applied to provide a test patch, which may for example comprise a disc or column of solidified material, which may be a few centimetres (e.g. 2 to 10 cm) in diameter.

Heat may then be applied to the first layer of build material, for example to cause at least a portion thereof to fuse in block 206. The fused portion may be any region of the layer to which fusing agent was applied. The first layer may be the first layer provided in the build operation or in other examples may be a subsequent layer. In one example, the first layer may be formed after one or more ‘blank’ layers. In some examples the first layer may be formed after one or more layers which are treated in a similar manner to the first layer, such that a test patch may be formed over a plurality of layers.

Block 208 comprises forming a second layer of build material on top of the first layer of build material. Block 210 comprises heating the second layer of build material, which may be clear of fusing agent. Blocks 212 and 214, which are carried out at least partially concurrently with block 210 comprises monitoring the temperature of at least part of the second layer of build material. More particularly, in this example, blocks 212 and 214 are effected by acquiring a heat map of the layer of build material. The heat map may, for example, be determined by measurement, for example using a thermal camera to capture a thermal image of the layer. In other examples, a heat map may be derived based on theory or thermal models of the first object (and any other object within the fabrication chamber) or the like.

Block 212 comprises monitoring the temperatures of a plurality of portions of the layer of build material which is intended to remain unfused in an additive manufacturing process. In the case of a calibration exercise, this may comprise any portion which does not overlie an underlying fused patch. In the case of object generation, this may comprise any portion of the layer of build material which is not intended to form part of an object.

Block 216 comprises controlling the power level of a first subset of an array of heating elements based on a measured temperature of a corresponding portion of the second layer of build material.

Block 214 comprises monitoring the temperature of at least part of a layer of build material within the additive manufacturing apparatus which is intended to fuse to determine, in block 218 the fusing temperature of the build material. This may be identified as an inflection on a temperature gradient over time graph. As the temperature of a region of build material will remain relatively stable while undergoing a phase change from solid to liquid, an increase in temperature indicates that the region of build material has fully melted and is therefore indicative of the melting temperature (or more particularly in some contexts, the melting temperature as measured by that thermal sensing apparatus).

Block 220 comprises controlling the power levels of the heating elements of a second subset of the array of heating elements according to the predetermined power regulation scheme. This may comprise controlling the heating elements to have a fixed power output. Block 216 may further comprise controlling the power level of the first subset of heating elements to be lower than the power level of the second subset of heating elements. However, in other examples, this may be reversed—i.e., the second subset may be controlled such that the power output is lower than the first subset of heating elements. For example, there may be a relatively high target temperature for the second subset of heating elements while the first subset of heating elements may be controlled so as to emit less (or even no) power.

In some examples, the method of FIG. 2 is carried out as part of a calibration exercise. In such examples, the method may continue until the monitored temperature in block 214 indicates that the temperature of all regions of the build material being monitored (i.e. all regions of the build material which it is intended to melt/fuse) have exhibited a change in temperature which is indicative of melting having occurred (in particular, an increase in the rate of temperature change). While the method of FIG. 2 is described in relation to a first and second layer, the method may be carried out over a plurality of successive layers. In some examples, blocks 202 to 206 may be carried out over a plurality of layers before the method proceeds to block 208.

In some examples, the fusing temperature determined in block 218 may be used as a set point of the additive manufacturing apparatus. For example, this may provide a calibration temperature which may be used during subsequent object generation exercises as indicating the melting temperature. Thus, in some examples, the method may further comprise using the determined temperature as a set point, or as the basis for a set point, in a subsequent additive manufacturing operation.

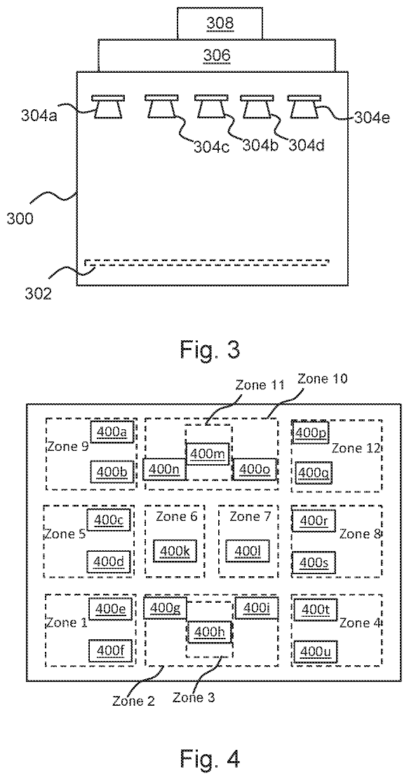

FIG. 3 is an example of an apparatus 300 comprising an array of individually controllable heating elements 304a-e to heat build material on a print bed 302 on which successive layers of build material are formed and temperature sensing apparatus 306 which, in use of the apparatus 300, senses at least one temperature of a first region of the print bed. The print bed 302 is shown in dotted lines for reference as it may not comprise an integral part of the print apparatus 300.

The apparatus 300 further comprises a controller 308. In use of the apparatus 300 the controller 308 is to control the heat output by each heating element such that, in a first mode of operation, a first heating element 304a of the array of heating elements is a variable heat output which is controlled according to the temperature of the first region of the print bed and a second heating element 304b of the array of heating elements 304 is controlled according to a predetermined heat output scheme which is independent of the temperature of the print bed. This may for example be fixed heat output.

In some examples, the first heating element 304a is positioned above the first region of the print bed 302, and the second heating element 304b is positioned above a second region of the print bed 302, wherein, when the controller 308 is operating according to the first mode of operation, the first region of the print bed 302 comprises build material which is intended to remain unfused and the second region of the print bed 302 comprises build material which is intended to fuse. The first heating element 304a is in a peripheral position within the array of heating elements 304 and the second heating element 304b is in a central position within the array of heating elements 304.

In some examples, in use of the apparatus 300, the controller 308 is to control the heat output by each heating element 304a-e such that, in a second mode of operation, the first and second heating elements are controlled according to a common control strategy.

For example, the first mode of operation may comprise a calibration/test mode whereas the second mode of operation may comprise an object generation mode. In the object generation mode, all of heating elements 304 may be controlled such that there heat output is varied using a feedback loop based on the temperature of the region of the print bed underlying that heating element 304 and/or based on a predetermined scheme. In some examples, during object generation, the control strategy applied to the heating elements may switch (for example, from open loop to closed loop). This may for example depend on the phase of the operation (for example, during preheating of build material one control strategy may be applied, whereas a different control strategy may be applied during a fusing phase). The object generation mode may use a temperature derived during the calibration/test mode as the basis for a set point of operation. However, it may be the case that all of the heating elements 304 are switched from one control strategy to another as a block, such that all the heating elements 304 operate according to a common control strategy at any one time.

A further mode of operation may be triggered by a temperature of the print bed reaching a threshold temperature, which may be a safety cut-off temperature. In the third mode of operation, the heat output of all heating elements may be stopped.

The temperature sensing apparatus 306 may for example comprise a thermal imaging camera to obtain a thermal map of the print bed, wherein the thermal map comprises a plurality of pixels, each pixel having an associated measured temperature. In other examples, temperature sensing apparatus 306 may comprise a thermal imaging sensor array, or some other thermal sensing apparatus, and may be used to determine one or more temperatures (which may be pixels of a heat map).

The apparatus 300 may comprise object generation apparatus 300 and may generate objects in a layer-wise manner by selectively solidifying portions of layers of build materials. The selective solidification may in some examples be achieved by selectively applying print agents, for example through use of ‘inkjet’ liquid distribution technologies, and applying energy, for example heat, to each layer. The object generation apparatus 300 may comprise additional components not shown herein, for example a fabrication chamber, a print bed, at least one print head for distributing print agents, a build material distribution system for providing layers of build material and the like.

The apparatus 300 may, in some examples, carry out at least one of the blocks of FIG. 1 or FIG. 2.

FIG. 4 shows an example of an arrangement of heating elements 400a-u and corresponding print bed zones 1-12. As can be seen, heating elements 400 can contribute to one or more overlapping zones and/or there may be more than one heating element per zone. In some examples, the control may be carried out on a zone by zone basis. For example, if a zone contains any material which is to be fused, the heating element(s) 400 affecting that zone may be controlled using a predetermined control scheme (e.g. having a fixed pulse width modulation duty cycle) whereas if a zone contains any material which is to be fused, the heating element(s) 400 affecting that zone may be controlled using a feedback loop based on a temperature of the zone, which may in some examples be an exemplary, or average, temperature of the zone (for example, the mean of the temperatures of the pixels in the zone). For example, such heating elements 400 may have a variable pulse width modulation duty cycle.

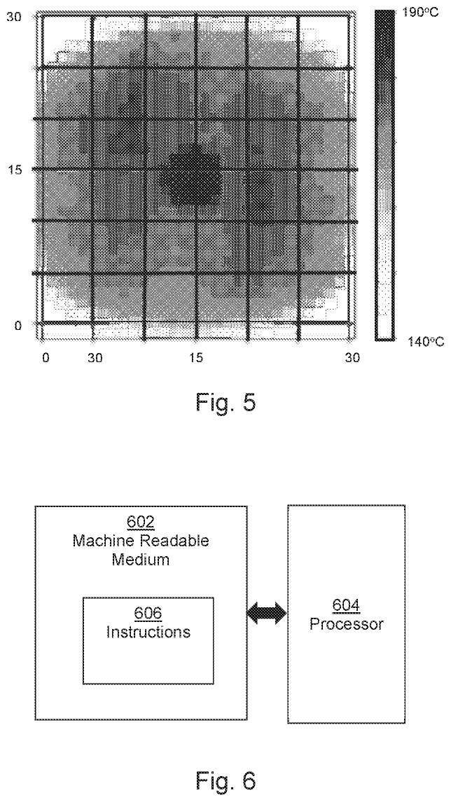

FIG. 5 shows an example of a heat map generated during a calibration/checking exercise as described above when forming a test patch of around 4 cm diameter in the centre of a print bed. The darker the shading, the higher the temperature of the pixel. The heat map in this case is acquired when the blank layer of build material which overlies a fused test patch is undergoing heating to cause fusion therein. As can be seen, there is a distinct difference between the test patch (which corresponds to around nine central pixels of the heat map) and the surrounding regions. Moreover, the variability across those regions is relatively small: in other words, the temperature of the build material which is not intended to fuse is relatively uniform.

In the event that all the heating elements are controlled using open-loop control mechanisms, for example being controlled to emit a fixed power (albeit that the power of peripheral lamps may be lower than the power of central lamps) then the variation of temperature in regions of the layer of build material away from the fused patch may be expected to exhibit greater variability. In general, in addition, the overall temperature may be higher to ensure completion of the test. However this runs the risk of fusing, and reducing recyclability of build material which is not intended to fuse, and also of test failure due to overheating of the surrounding build material.

Table 1 below shows the comparative results of tests carried out using a fixed power output for all the lamps of a 20 heat lamp array in carrying out a test/calibration exercise in which a circular 4 cm diameter test patch was formed using a number of successive layers of build material to which fusing agent is applied, and which have been overlaid with a layer of ‘blank’ build material (i.e. a layer to which no fusing agent is applied). In this example, the build material is PA12, and the target temperature used for the feedback control loop was set to 175° C. (this temperature was 10° C. below the ‘safety’ test abort temperature of 185° C. of the test). The power output values were achieved using Pulse Width Modulation (PWM). The fixed power output was achieved using a fixed PWM duty cycle, and the PWM duty cycle was variable when a feedback loop was employed.

TABLE 1

| | | | central lamps fixed | |
|---|---|---|---|---|
| | Fixed power output, | | power outputs 95%, | |
| | central lamps 95%, | | peripheral lamps using | |
| | peripheral lamps 50% | | feedback loop | |
| Maximum temperature | 190° | C. | 185° | C. |
| Mean temperature | 180.32° | C. | 174.90° | C. |
| Modal temperature | 182.00° | C. | 173.00° | C. |
| Standard deviation | 5.93° | C. | 3.38° | C. |
| Range | 34° | C. | 23° | C. |

The reduction in variability of temperature across the print bed increases the predictability of the exercise and results in fewer failures due to time out and overheating of the build material which it is intended to remain unfused. It may be noted that the average temperatures are also reduced, saving energy.

FIG. 6 shows a tangible (non-volatile) machine readable medium 602 associated with a processor 604. The machine readable medium 602 comprises instructions 606 which, when executed by the processor 604, cause the processor 604 to perform processing actions. The instructions 606 comprise instructions to cause the processor 604 to control the output of a first subset of heating elements of an array of heating elements within an additive manufacturing apparatus based on the temperature of a region of a layer of build material within a fabrication chamber of the additive manufacturing apparatus using a closed-loop control method. The instructions 606 further comprise instructions to control the output of a second subset of the heating elements of an array of heating elements within an additive manufacturing apparatus according to a predetermined scheme. Each subset may comprise at least one heating element.

In some examples, the instructions 606 may comprise instructions to cause the processor 604 to determine a zone of the layer of build material which is heated by the second subset of heating elements, monitor the temperature of the zone and to determine a fusing temperature of the build material based on the temperature characteristics of the zone. In such examples, the machine readable medium 602 may further comprise instructions which when executed by the processor, cause the processor 604 to set the determined fusing temperature as the basis of a set point of the additive manufacturing apparatus. For example, this may provide a calibration temperature which may be used during subsequent object generation exercises as indicating the melting temperature of the build material as measured by the temperature monitoring apparatus.

In some examples, the instructions 606 may comprise instructions to cause the processor 604 to control the output of the second subset of heating elements comprise instructions to cause the second subset of heating elements to output heat at a predetermined fixed level. The predetermined fixed level may, in some examples be generally higher than the output of the first subset of heating elements.

In some examples, the machine readable medium 602 comprises instructions 606 to carry out at least one of, or combinations of, the blocks described above in relation to FIG. 1 or FIG. 2, and/or to provide at least part of the controller 308.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that at least some flows and/or blocks in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry may execute the machine readable instructions. Thus functional modules of the apparatus (such as the controller 308) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims, in any combination.

1. A method of operating a three-dimensional printing system comprising:
monitoring a temperature of a layer of build material within an additive manufacturing apparatus;
controlling a power level of a first heating element heating the layer of build material based on the monitored temperature; and
controlling a power level of a second heating element heating the layer of build material according to a predetermined power level scheme.

2. A method according to claim 1 wherein monitoring the temperature of the layer of build material comprises monitoring the temperature of a part of the layer of build material which is intended to remain unfused in an additive manufacturing process.

3. A method according to claim 1 comprising:
forming a first layer of build material on a print bed of the additive manufacturing apparatus,
selectively applying fusing agent to the first layer of build material;
heating the first layer of build material;
forming a second layer of build material on top of the first layer of build material;
heating the second layer of build material;
monitoring a temperature of at least part of the second layer of build material; and
controlling the power level of the first heating element based on the monitored temperature of the second layer of build material.

4. A method according to claim 1 comprising measuring a temperature of at least part of a layer of build material within the additive manufacturing apparatus which is intended to fuse to determine a fusing temperature of the build material.

5. A method according to claim 1 wherein controlling the power levels of the first and second heating elements comprises controlling the power level of the first heating element to be lower than the power level of the second heating element.

6. A method according to claim 1 wherein the additive manufacturing apparatus comprises an array of heating elements, and the method comprises:
monitoring a plurality of temperatures of a layer of build material within the additive manufacturing apparatus;
controlling a power level of each of a first subset of heating elements based on associated monitored temperatures of the plurality of monitored temperatures; and
setting a power level of a second subset of heating elements to the predetermined power level scheme.

7. An apparatus comprising:
an array of individually controllable heating elements to heat build material on a print bed on which successive layers of build material may be formed in additive manufacturing;
temperature sensing apparatus to sense a temperature of a first region of the print bed; and
a controller to control a heat output by each heating element such that, in a first mode of operation, a first heating element of the array of heating elements is a variable heat output which is controlled according to the temperature of the first region of the print bed and a second heating element of the array of heating elements is controlled according to a predetermined heat output scheme which is independent of the temperature of the print bed.

8. An apparatus according to claim 7 in which the controller is to control the heat output by each heating element such that, in a second mode of operation, the first and second heating elements are controlled according to a common control strategy.

9. An apparatus according to claim 7 in which the first heating element is positioned above the first region of the print bed, and the second heating element is positioned above a second region of the print bed, wherein, when the controller is operating according to the first mode of operation, the first region of the print bed comprises build material which is intended to remain unfused and the second region of the print bed comprises build material which is intended to fuse.

10. An apparatus according to claim 7 wherein the first heating element is in a peripheral position within the array of heating elements and the second heating element is in a central position within the array of heating elements.

11. An apparatus according to claim 7 wherein the temperature sensing apparatus comprises a thermal imaging camera to obtain a thermal map of the print bed, wherein the thermal map comprises a plurality of pixels, each pixel having an associated measured temperature.

12. Tangible machine readable medium comprising instructions which, when executed by a processor, cause the processor to:
control the output of a first subset of heating elements of an array of heating elements within an additive manufacturing apparatus based on a temperature of a region of a layer of build material within a fabrication chamber of the additive manufacturing apparatus using a closed-loop control method; and
control an output of a second subset of heating elements of an array of heating elements within an additive manufacturing apparatus according to a predetermined scheme.

13. Tangible machine readable medium according to claim 12 further comprising instructions which, when executed by the processor, cause the processor to:
determine a zone of the layer of build material which is heated by the second subset of heating elements;
monitor the temperature of the zone; and
determine a fusing temperature of the build material based on temperature characteristics of the zone.

14. Tangible machine readable medium according to claim 13 further comprising instructions, which when executed by the processor, cause the processor to set the determined fusing temperature as a basis of a set point of the additive manufacturing apparatus.

15. Tangible machine readable medium according to claim 12 in which the instructions to control the output of the second subset of heating elements comprise instructions to cause the second subset of heating elements to output heat at a predetermined fixed level.
